(19) United States
(12) Patent Application Publication
(10) Pub. No.: US 2013/0341528 A1
(43) Pub. Date: Dec. 26, 2013

(54) Matrix-Incorporated Fluorescent Silica with On/Off Functionality for Anti-Counterfeiting

(71) Applicants: Dylan J. Boday, Tucson, AZ (US); Jason T. Wertz, Wappingers Falls, NY (US)

(72) Inventors: Dylan J. Boday, Tucson, AZ (US); Jason T. Wertz, Wappingers Falls, NY (US)

(73) Assignee: INTERNATIONAL BUSINESS MACHINES CORPORATION, Armonk, NY (US)

(21) Appl. No.: 13/528,166

(22) Filed: Jun. 20, 2012

(51) Int. Cl. C07F 7/18; G01N 21/64

(52) U.S. Cl. 250/459.1; 556/433; 250/200

(57) ABSTRACT

A fluorescent material includes a silica matrix, and a fluorescent dye compound covalently bonded to the silica matrix. The fluorescent dye compound may have first and second absorption wavelengths and an emission wavelength. A method for producing a photoswitchable fluorescent material includes combining silane monomers and fluorescent silane dyes, and initiating a polymerization reaction between the silane monomers and the photoswitchable fluorescent silane dyes, thereby creating photoswitchable fluorescent dye compounds covalently bonded to a silica matrix. The authenticity of a product may be verified according to a method in which a fluorescent material is present in or on a product, and the material is tested for fluorescence at first and second absorption wavelengths, the presence of structural characteristics, or both. The fluorescent material may exhibit on/off functionality through the use of the fluorescent material at different absorption wavelengths.

### TECHNICAL FIELD

This disclosure is generally directed to fluorescent dye-incorporated silica, and methods for producing and using fluorescent dye-incorporated silica. One such usage may be for the verification of the authenticity of a product.

### BACKGROUND

Silica consists of silicon and oxygen. Due to the silicon's tetrahedral structure, and upon reaction with oxygen, silica matrices can be formed. Silica matrices may form amorphous structures, such as mesoporous silica, which are unordered structures. A silica matrix can be used to form silica particles and silica films. During the formation of silica, the siloxane network can grow to a size which causes phase separation into silica particles. A silica matrix can be formed on other surfaces as a coating. These silica particles and coatings have many applications in many fields, including agriculture, industry, and medicine.

### SUMMARY

In one embodiment, a fluorescent material comprises a silica matrix and a fluorescent dye covalently bonded to the silica matrix. The fluorescent dye has first and second absorption wavelengths and a first emission wavelength, and emits measurably different light at the first and second absorption wavelengths.

In another embodiment, a method for producing a fluorescent material comprises combining silane monomers and fluorescent silane dyes having first and second absorption wavelengths and a first emission wavelength, wherein the fluorescent silane dyes emit measurably different light in response to light at the first and second absorption wavelengths. In addition, the method includes initiating a polymerization reaction between the silane monomers and the fluorescent silane dyes, thereby creating fluorescent dye compounds covalently bonded to a silica matrix.

In another embodiment, a method for verifying authenticity of a product comprises exposing a fluorescent material to light at a first absorption wavelength and detecting light at a first emission wavelength to verify authenticity of the product. The fluorescent material comprises a silica matrix and fluorescent dyes covalently bonded to the silica matrix. The fluorescent dyes have the first absorption wavelength, a second absorption wavelength, and the first emission wavelength, and emit measurably different light in response to light at the first and second absorption wavelengths.

### BRIEF DESCRIPTION OF THE DRAWINGS

The drawings illustrate embodiments of the invention and, along with the description, serve to explain the principles of the invention. The drawings are illustrative of typical embodiments of the invention and do not limit the invention.

FIG. 1 depicts polymerization of a bridged silane dye monomer and alkoxysilane monomers to form a silica matrix, according to an embodiment.

FIG. 2 depicts methods for using fluorescent dye-incorporated silica to verify product authenticity, according to various embodiments.

### DETAILED DESCRIPTION

A fluorescent material may include a fluorescent dye incorporated into a silica matrix through covalent bonds. This structural incorporation of the dye into the matrix may aid in preventing the dye from leaching out of a material and may be achieved in a single processing step. Leaching is a phenomenon involving the washing out of a substance in a material by physical or chemical processes, such as diffusion. Leaching may occur during formation, use, or storage of a substance. Leaching may reduce the effectiveness of a substance, as leaching decreases the effective amount of the substance in the material. In the context of encapsulated fluorescent dyes, leaching may decrease the intensity or durability of the encapsulated dye. For applications such as product verification, this may have significant consequences.

Additionally, by incorporating a fluorescent dye into a silica matrix, the surface of the fluorescent material is available for surface modification. These surface modifications may include additional dyes, functional groups for bonding into polymers, and other functionalities.

A fluorescent property of the fluorescent material may provide an on/off function. Specifically, the fluorescent material may fluoresce differently under different frequencies of applied light, and this response characteristic of the material may be changed by a conditioning event. This on\off functionality may be achieved with the use of a single dye having two absorption wavelengths that correspond to two different intensities for a given emission wavelength. Alternatively, this on\off switching may be achieved with a photoswitchable dye, which cycles between fluorescent and non-fluorescent states.

In one embodiment, fluorescence may be achieved through the use of a fluorescent silane dye. The fluorescent dye may be a single fluorescent, non-photoswitchable dye having fluorescent absorption wavelengths which cause the dye to emit light of particular intensities at particular absorption wavelengths. If the difference in emitted intensity for different applied wavelengths of light is substantial enough to be observed or measured, then the action of switching between the applied wavelengths of light effectively turns the dye's fluorescence on at one absorption wavelength and off at another absorption wavelength. In this way, when the relative fluorescence of the dye is observed or measured at a specified wavelength, the fluorescent dye acts as an on\off switch for fluorescence. One or more of the absorption wavelengths of light applied to the dye may be a peak absorption wavelength of the dye.

The light emissions which constitute “on” and “off” states may vary depending on the way in which the emitted light emissions are detected or observed. If the dye is intended to be examined unaided, the “on” state may correspond to a first absorption wavelength which causes a dye to emit light at an intensity near to the intensity expected for a peak absorption wavelength. The “off” state may correspond to a second absorption wavelength having an intensity substantially less than the intensity associated with the “on” state, perhaps around 0-10% of the intensity associated with the peak absorption wavelength. In this instance, the difference in intensity between the “on” and “off” states may be clear to an unaided eye. On the other hand, if a detection apparatus is used, the difference in intensities between the “on” and “off” states may be significantly smaller than the intensity differences associated with the unaided technique. An exemplary detection apparatus may include a photo detector and a filter.

The switching action between the “on” and “off” states may be effectuated by a conditioning event, where the conditioning event changes the response characteristics of the dye. If a non-photoswitchable fluorescent dye is used, the conditioning event may be a shift from the application of light at a first predetermined absorption wavelength to light at a second predetermined absorption wavelength, or vice versa. Alternatively, if a photoswitchable fluorescent dye is used, the conditioning event may be an application of light at a first absorption wavelength that causes a structural change in the dye molecules corresponding with a shift from a non-photoswitched state to a photoswitched state. In addition, a conditioning event for a photoswitchable fluorescent dye may be an application of light at a second absorption wavelength that causes a reversal of the structural change in dye molecules corresponding with a shift from a photoswitched state to a non-photoswitched state. In effectuating the conditioning event, the first and second absorption wavelengths may differ more for an unaided observation technique than for an aided observation technique. For example, for unaided switching, the first absorption wavelength may first be provided with a light source emitting at around 700 nm and the second absorption wavelength may be provided secondly with a light source emitting around 500 nm, where these absorption wavelengths correspond to substantially or measurably different intensities at a predetermined emission wavelength. The fluorescent material's manufacturer may provide specifications for the expected absorption wavelengths and their corresponding intensities.

Alternatively, fluorescence may be tuned to a particular molecular state through the use of a photoswitchable fluorescent dye, acting as an on/off switch for the fluorescent state itself. An added benefit of a photoswitchable dye is that more than one emission wavelength may be provided with a single dye. Photoswitchable fluorescent dyes exhibit two or more stable and reversible states, such as a fluorescent state and a non-fluorescent state, where the states depend on the protonation or molecular orientation of the dye molecule. The fluorescent state has absorption and emission wavelengths different from the non-fluorescent state, allowing the dye to cycle between fluorescence and non-fluorescence by changing the radiative emissions applied to the dye. Alternatively, both states may be fluorescent, depending on the dye used.

According to principles of the invention, a substance containing a fluorescent material, such as paint, ink, or another physical substance, may provide for two levels of security for determining product authenticity. At a first level of security, the substance may contain a fluorescent material with a fluorescent dye integrated into a silica matrix of the fluorescent material, the fluorescent dye having at least two absorption wavelengths and at least one emission wavelength, where the fluorescent dye emits measurably different light at the absorption wavelengths. The parameter of light measured may be the intensity of light emitted at a particular wavelength when light of a certain power and absorption wavelength is applied to the dye. By selecting a fluorescent dye with multiple absorption wavelengths that correspond to different intensities at a given power of light, goods marked or imbued with the fluorescent material may be uniquely tagged. The emission wavelengths of the fluorescent dye may be any selected or predetermined wavelength in a large range of wavelengths. For example, one of the absorption wavelengths may be in the ultraviolet spectrum, while the emission wavelength may be in the visible spectrum.

In one embodiment, a photoswitchable fluorescent dye has two emission wavelengths. The emission wavelengths of the fluorescent dye may be any selected or predetermined wavelength in a large range of wavelengths. In one embodiment, a first emission wavelength may be emitted in a fluorescent state and a second emission wavelength may be emitted in a non-fluorescent state. Alternatively, the first emission wavelength may be emitted in a first fluorescent state and the second first emission wavelength may be emitted in a second fluorescent state. In another embodiment, a photoswitchable fluorescent dye has first and second emission wavelengths, and one of the first and second emission wavelengths is at or above the visible spectrum. While the addition of different fluorescent dyes is possible for the fluorescent material's manufacturer, detection of those different fluorescent dyes may be difficult for counterfeiters.

At a second level of security, microscopic structural characteristics or features of the fluorescent material may be used for identification. Silica particles or silica layers formed from the fluorescent material may be controlled for size and structure on a microscopic level. Observation of the size and structure of the fluorescent material on a microscopic scale may require an electron microscope or similar apparatus. Such equipment may be prohibitively expensive for most counterfeiters, and this expense acts as an obstacle to making counterfeit goods. These two security levels together may form a two-tiered system of protection, which may be tailored to the quality, value, or other characteristic of an item.

### Material Structure

In an aspect of the invention, a fluorescent material includes a silica matrix. This silica matrix may be polymerized from silane monomers, which form a network through covalent siloxane bonds. During material formation, a fluorescent silane dye may form siloxane bonds with the silane monomers and integrate into the silica matrix to form a photoswitchable fluorescent material. The resulting silica matrix will include silicon and oxygen forming siloxane bonds, as well as fluorescent dyes covalently bonded to silicon atoms. Due to this integration, a leach-resistant dye may be produced without an additional polymer shell, and the particle may be produced in a single step. After material formation, the surfaces of the fluorescent material retain hydroxyl functional groups generated from incomplete condensation of the silica matrix. This surface may then be modified to change the fluorescent material's dispersion properties. The surface may be further modified with additional fluorescent dyes, functionalities to target specific regions within biological systems, and other functionalities to aid in application where a fluorescent core may be used. The size of the fluorescent material may be controlled for homogeneity. Fluorescent silane dyes that may be used include, but are not limited to, fluorescent vinyl silane dyes and fluorescent pyrene silane dyes.

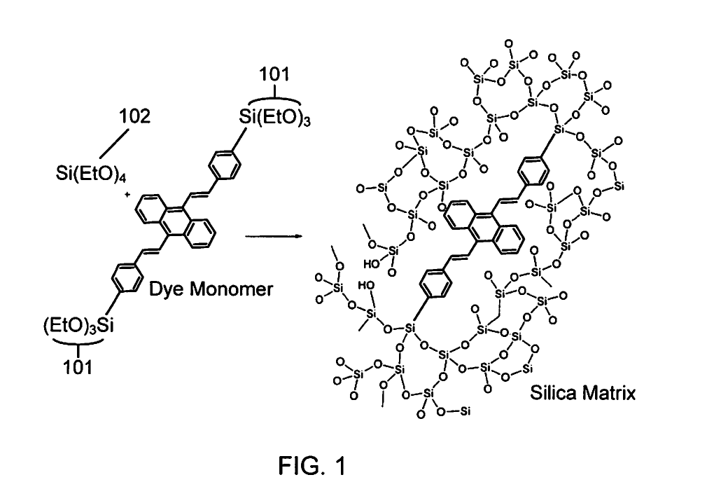

In an aspect of the invention, a bridged fluorescent silane dye may be used to form a silica matrix with silane monomers. The bridged fluorescent silane dye may have up to six sites—three on each of the two silicon atoms—for covalently bonding into the structure of the silica matrix, as seen in FIG. 1. As mentioned above, these covalent bonds may help prevent leaching of the dye. The bridged fluorescent silane dye may have an emission wavelength anywhere on the electromagnetic spectrum, depending on the desired fluorescent properties of the dye. Bridged fluorescent silane dyes that may be used include, but are not limited to, 4,4′-bis(4-(triethoxysilyl)styryl)biphenyl and N,N′-bis(3-triethoxysilylpropyl)-perylene-3,4:9-10-tetracarboxdiimide.

FIG. 1 depicts incorporation of a bridged fluorescent silane dye into a silica matrix, according to aspects of the invention. A dye monomer has two silane sites 101. One or both silane sites 101 form siloxane bonds with a silica monomer 102, in this case tetraethyl orthosilicate, to form a silica matrix, where the dye is part of the matrix.

In another aspect of the invention, a photoswitchable bridged fluorescent silane dye may be used to form a silica matrix with silane monomers. Such photoswitchable dyes include, but are not limited to, silane-functionalized cyanine dyes, silane-functionalized carbocyanine dyes, silane-functionalized rhodamine dyes, silane-functionalized oxazine dyes, and silane-functionalized diarylethene dyes.

According to various embodiments, the fluorescent material may form fluorescent silica particles or fluorescent silica layers. Silanol functionalities retained on the surface of the fluorescent material may be used for further modification, and the fluorescent material's properties may be changed in order to better disperse it in aqueous or organic dispersions or to reduce agglomeration. Functional groups on the surface of the fluorescent material may change the polarity of the material's surface, or decrease the van der Waals interactions between particles of the material, which may increase material dispersion and decrease material agglomeration. In one aspect, a surface of the fluorescent material contains a functional group that increases the dispersion of the material in a particular medium or decreases agglomeration of the particles. For example, a functional group may be selected for its hydrophobic properties, such as a phenyl group, for dispersion in organic or oil-based dispersions. The functional group used for surface modification may differ with the properties of the substance in which it is dispersed. Such functional groups for surface modification may include, but are not limited to, polyethylene glycol, carboxyl, amino, methyl, and benzyl.

### Material Formation

In an aspect of the invention, a fluorescent material may be formed by polymerization of silane monomers. These silane monomers undergo hydrolysis and condensation reactions to form covalent bonds, forming a silica matrix. These silane compounds include fluorescent silane dyes, which have one or more bonding sites to form siloxane bonds.

In an embodiment, fluorescent silica nanoparticles may be formed using the Stöber process, which may create monodisperse silica particles. In the Stöber process, alkoxysilane compounds, such as tetraethyl orthosilicate (TEOS), are mixed with a water, ammonia, and alcohol solution to form an alkoxysilane solution. Alkoxysilane compounds undergo hydrolysis, forming silanol compounds and alcohols. Alkoxysilane compounds may undergo both alcohol condensation, in which an alkoxysilane compound reacts with a silanol compound, and water condensation, in which a silanol compound reacts with another silanol compound. These condensation reactions produce a silica matrix. The above described reactions may be as follows:

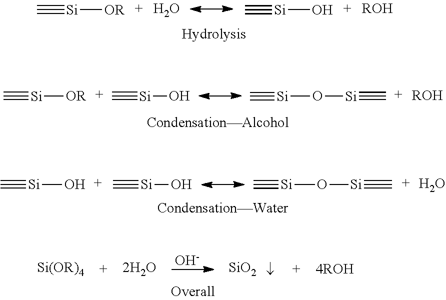

where R may be an alkyl group. The size of the silica particles formed by this process may be controlled through changing the amount of water or ammonia used in the process. Any alkoxysilane compound may be used as a silica monomer in material formation including, but not limited to, tetraethyl orthosilicate (TEOS) and tetramethyl orthosilicate (TMOS).

The Stöber process may be modified to covalently incorporate a fluorescent dye into the silica matrix by adding one or more fluorescent silane dyes to the initial alkoxysilane solution. These fluorescent silane dyes may undergo hydrolysis by the same mechanism as an alkoxysilane compound, and form up to three siloxane bonds with the silica matrix on each of its trialkoxysilyl groups, for a total of up to six bonds.

In another embodiment, the fluorescent material may be formed using a microemulsion process. A microemulsion process may contain the same hydrolysis and condensation steps as those of the Stöber process documented above, but the environment for polymerization may be different. In one embodiment of the invention, a surfactant is mixed with a water and ammonia solution to form an aqueous phase. Alkoxysilane monomers and bridged fluorescent silane dyes are dispersed into the aqueous phase, forming micelles with the surfactant in the aqueous phase. A polymerization reaction is initiated between silane monomers and silane dyes within the micelles, forming a silica matrix. Any surfactant may be used, including but not limited to non-ionic polyoxyethylene nonylphenyl ether, polyethylene glycol alkyl ether, and sodium dodecyl sulfate. If desired, an oil solvent may be added to the aqueous phase to form part of the micelles with the silane compounds. Oil solvents that may be used include, but are not limited to, toluene, cyclohexane, and heptane.

In an embodiment of the invention, the fluorescent material may have a dispersive functional group on its surface. The dispersive functional group may be attached to a silanol group on the fluorescent material's surface to increase dispersion of the fluorescent material in different media, such as paints and oils, or decrease agglomeration of the fluorescent material. In an embodiment, the fluorescent material is treated with a dispersive functional group, such as a hydrophilic polyethylene glycol. For example, a silane agent may be used to attach the polyethylene glycol to hydroxyl groups on the surface of a silica particle, as described in the experimental section below.

### Product Verification and Anti-Counterfeit Security

According to the principles of the invention, a substance containing a fluorescent material may be an ink, paint, or other physical substance used to coat all or a portion of a surface of any product. In addition, fluorescent silica material, according to the principles of the invention, may be a part of the substance used to make all or part of any product. For example, a product may include a part made from a substance that includes fluorescent material dispersed in that substance. Moreover, the material may be used in or on packaging for or a tag attached to any product.

A “product” may be any suitable product. Further, a product may be any packaging surrounding or attached to a product. A product may be any product used by business, government, or consumers. Examples of products include any integrated circuit and any circuit board having parts formed from or painted with a substance having a fluorescent material, according to the principles of the invention. Other examples include consumer products, such as handbags, clothing, shoes, watches, jewelry, and electronic devices, such as cellular telephones having any part formed from a substance containing a photoswitchable fluorescent material, according to the principles of the invention, or having a portion of a surface coated or painted with a substance containing a photoswitchable fluorescent material, according to the principles of the invention. In one embodiment, a “product” may be a tag attached to a consumer product, such as an article of clothing, wherein the tag may be formed from or painted with a substance having a fluorescent material, according to the principles of the invention. An additional example of a product having a substance formed from a fluorescent material, according to the principles of the invention, may be packaging for any pharmaceutical product. For example, pharmaceuticals are commonly packaged in plastic bottles with labels affixed to the bottles. The plastic from which a bottle is made may include fluorescent material as described herein or a label affixed to the bottle may have an ink printed thereon that includes photoswitchable fluorescent material as described herein. As an additional example, a pharmaceutical product, such as a tablet or a capsule, may include a material having photoswitchable fluorescent material as described herein.

In one embodiment, a fluorescent material may have a fluorescent dye integrated into a silica matrix. The fluorescent dye may have an emission wavelength in or above the visible spectrum. For example, in one embodiment, the fluorescent dye may have an emission wavelength of greater than 750 nm. As another example, the fluorescent dye may have an emission wavelength of greater than 390 nm. In this example, the silica particles may be surface modified with a polarizing functional group and dispersed into a polar application system, such as an aqueous paint. The paint may be applied to a product. In one embodiment, the product may be irradiated with radiation at a wavelength of 365 nm to check for fluorescence at 400 nm. In another embodiment, the fluorescent dye may have at least one absorption wavelength in the ultraviolet spectrum and an emission wavelength in the visible spectrum.

In another embodiment of the invention, a fluorescent material may have a photoswitchable fluorescent dye integrated into a silica matrix. For example, the photoswitchable fluorescent dye may have a first fluorescent state that “switches on” at a wavelength 405 nm and emits radiation at a first emission wavelength of 518 nm. The photoswitchable fluorescent dye may have a second non-fluorescent state that “switches off” at a wavelength of 488 nm. In the off state, the fluorescent dye may emit radiation at a second emission above a wavelength of 488 nm. One of the first and second emission wavelengths may be at or above the visible spectrum. In an alternative embodiment, both of the first and second emission wavelengths may be at or above the visible spectrum. Further, while the photoswitching is generally reversible, a large number of repetitions of photoswitching may eventually cause photobleaching of the fluorescent dye to occur, essentially turning the dye into a photo-activating dye. This may allow a user to permanently mark a product at a stage in the security authorization process by taking away its photoswitchable function.

In one embodiment, the fluorescent material may be present in a substance in a concentration sufficient to affect the intensity of the substance's fluorescence. In one embodiment of the invention, the concentration of the fluorescent material dispersed in a substance may be varied to change the intensity of the fluorescence, as an additional security check for counterfeiting. The fluorescent material may be present in any concentration sufficient to allow the material to fluoresce at a desired intensity for an application. In one embodiment, a material may fluoresce at an intensity that may generally be observed without the aid of any equipment or machine. In an alternative embodiment, the material may fluoresce at an intensity that may generally be observed with the aid of equipment or a machine. In another alternative embodiment, a material may fluoresce at one or more emission wavelengths at or above the visible spectrum, requiring the use of equipment or a machine to detect fluorescence.

In another embodiment, the authenticity of a product may be determined by examining microscopic features of a substance in or on the product using alternative microscopic techniques, such as electron microscopy. Silica particles, according to the principles of the invention, may be applied to a product as an ink, paint, or coating. Moreover, the substance from which any part of the product is made may include the fluorescent material, according to the principles of the invention. The region of the product where the material containing silica particles is painted or coated may be examined with an electron microscope. Similarly, a part of the product that is made from a substance that includes the fluorescent material may be examined with an electron microscope. The use of an electron microscope allows a structural characteristic such as the size or shape of the silica particles, formed from the fluorescent material, to be examined. For example, the process of forming silica particles may be controlled in order to create silica particles of a certain homogeneous size or shape, such as through changing the concentration of products or reactants during the reaction. To test for product authenticity, the size or shape of silica particles in a material may be inspected and compared with the “controlled for” size or shape of the silica particles. For particularly expensive or unique products, a counterfeiter may determine the proper emission wavelengths for the fluorescent dyes, and apply them to the counterfeit product, but might not properly determine the size or physical structure of the silica particles. The inspection of silica particle shape or size using electron microscopy may be in addition to or as alternative to other embodiments described in this description, e.g., the integration of fluorescent dyes.

These different levels of security may be tailored to an anti-counterfeit system according to the needs of the business and characteristics of the product. For selected items, based on the items' cost, importance, or other distinguishing factor, a system may be tailored to test for fluorescence at one or more predetermined wavelengths. But for more expensive or unique items, the electron microscope may be applied. The actual anti-counterfeiting medium need not change, only the systems used to check for counterfeiting, though characteristics of the material such as dilution may be changed to allow for customization.

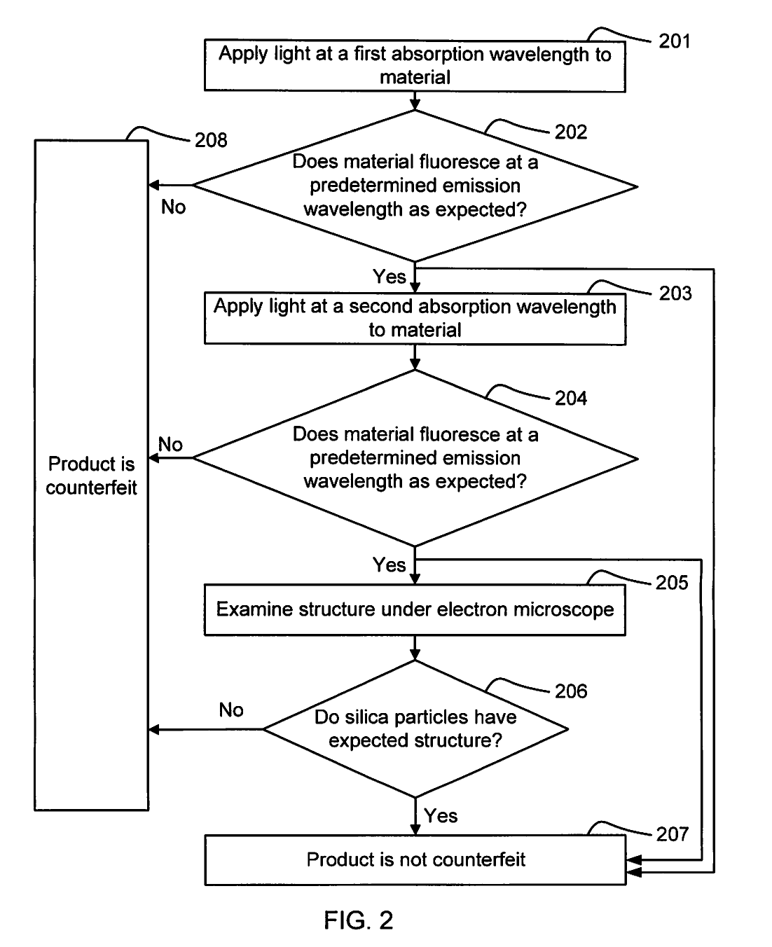

FIG. 2 depicts an exemplary method for determining whether a product is authentic, according to embodiments of the invention. In 201, a product having a fluorescent material, according to the principles of the invention, is exposed to light of a first predetermined absorption wavelength. In 202, fluorescence may be checked at a predetermined emission wavelength; if the material does not fluoresce correctly, then it may be determined that the product is not authentic, i.e. counterfeit, as in 208. On the other hand, if the material does fluoresce correctly, it may be determined that the product is authentic, as in 207.

Alternatively, in operation 202, it may be determined if the material fluoresces at a predetermined emission wavelength and at a first predetermined intensity i.e. “as expected”. If the material does not fluoresce at the correct wavelength and intensity, then it may be determined that the product is not authentic, as in 208. On the other hand, if the material does fluoresce at the correct emission wavelength and intensity, it may be determined that the product is authentic, as in 207.

Additionally, the material may be tested for on\off fluorescent functionality through the use of two predetermined absorption wavelengths. In operation 203, the product is exposed to light of a second predetermined absorption wavelength. In 204, fluorescence may be checked at the predetermined emission wavelength at a second predetermined intensity, i.e. “as expected”. If the material does not fluoresce at the second predetermined intensity, then it may be determined that the product is not authentic, as in 208. On the other hand, if the material does fluoresce at the expected intensity, it may be determined that the product is authentic, as in 207. In one embodiment, the first predetermined intensity may correspond to an “on” state and the second predetermined intensity may correspond to an “off” state. In the context of the on\off functionality, a predetermined intensity does not have to involve specific measured values as to the intensity, provided the respective emissions are observably or measurably different; rather, the first and second predetermined intensities may only be substantially or measurably different relative to one another to determine product authenticity.

Alternatively, if the dye used is a photoswitchable dye, it may be desired to check for the “switching on” and “switching off” of fluorescence at particular wavelengths associated with the dye. The photoswitchable dye may need to first be toggled to a default state by applying a conditioning event to cause a change in state. This change in state may be from the photoswitched “on” state to the non-photoswitched “off” state, if required; however, in another embodiment, the process is carried out with the initial states of the photoswitchable dye reversed. In an embodiment, light at a first absorption wavelength corresponding to a photoswitched state may be applied to the product, as in 201. In operation 202, it may be determined if the fluorescence “switches on”. If the material starts fluorescing at a first emission wavelength associated with the photoswitched state, it may be determined that the product is authentic, as in 207. On the other hand, if the material does not start fluorescing at the first emission wavelength, then it may be determined that the product is not authentic, as in 208. Alternatively, one or more additional tests may be performed. In another embodiment, light at a second absorption wavelength corresponding to a non-photoswitched state may be applied to the product, as in 203. In operation 204, it may be determined if the fluorescence “switches off”. If the material starts fluorescing at a second emission wavelength associated with the non-photoswitched state, it may be determined that the product is authentic, as in 207. On the other hand, if the material does not start fluorescing at the second emission wavelength, then it may be determined that the product is not authentic, as in 208.

In one embodiment an additional test is performed in operation 205. In operation 205, the microscopic structure of the silica particles may be examined using electron microscopy or a similar technique. Operation 205 may include inspecting the size or shape or other structural characteristic of the fluorescent material in a substance and comparing an observation with an expected or “controlled for” size or shape of the fluorescent material. In operation 206, it may be determined if the observed structural characteristic is substantially the same as the expected structural characteristic. If the expected structure is not observed, then it may be determined that the article is not authentic, as in 208. If the expected structure is observed, then it may be determined that the product is genuine, as in 207.

### Illustrative Experimental Protocols

The following illustrative experimental protocols are prophetic examples and may be reproduced in a laboratory environment.

1. Preparation of Fluorescent Silica Particles Under StöBer Conditions—TEOS, One Fluorescent Dye

Dyes are prepared by mixing together solutions A and B. Solution A contains ammonia (2M, 3.75 mL) and water. Solution B contains tetraethyl orthosilicate (TEOS, 0.355 g., 1.7 mmoles) and 4,4′-bis((4-triethoxysilyl)styryl)biphenyl (0.01-1.0 mol % of TEOS) diluted to 5 mL with anhydrous ethanol. Solution A is added quickly to solution B and mixed using a stir bar for approximately 24 hours at room temperature, with the total volume at 10 mL. Particle formation begins within a few minutes.

### 2. Preparation of Fluorescent Silica Particles Under Microemulsion Conditions—TEOS, One Fluorescent Dye, 200 Nm MCM-41-Type Mesoporous Silica Nanoparticles

Particles are prepared through a modified Lai et al. synthesis using n-cetyltrimethylammonium bromide (CTAB), sodium hydroxide, deionized water, and tetraethyl orthosilicate (TEOS). All chemicals used are as purchased. CTAB (1.00 g., 2.74×10⁻³ mol) is dissolved in deionized water (480 mL) in a 1000 mL round bottom with a condenser. NaOH (2.00 M, 3.50 mL) is then added to the CTAB solution, and the temperature is raised to 80° C. using an oil bath. TEOS (6.2 mL, 2.78×10⁻² mol) and the bridged fluorescent silane dye (0.01-1.0 mol % of TEOS) are then added to the surfactant solution. The mixture is stirred (440 rpm) for 2 hr to give rise to white precipitates.

The solid product is filtered, washed with deionized water and methanol, and dried in air. To remove the surfactant template (CTAB), 1.50 g. of synthesized nanoparticles are refluxed for 24 hr in a solution of HCl (9.00 mL, 37.4%) and methanol (160 mL), followed by extensive washes with deionized water and methanol. The resulting surfactant-removed silica nanoparticles are dried in vacuo to remove remaining solvent in the mesopores.

### 3. Surface Modification of Fluorescent Silica Particles—Polyethylene Glycol, MCM-41-Type Mesoporous Silica Nanoparticles

Particles are prepared as described above. Dried particles are dispersed in a solution of methoxy-polyethylene glycol-silane (3 mM) in THF or toluene. Particles are stirred for 4 hr at 60° C. The solution is then filtered and extensively washed with toluene and ethanol, and dried in vacuo.

What is claimed is:

1. A fluorescent material, comprising:
a silica matrix;
a fluorescent dye covalently bonded to the silica matrix, the fluorescent dye having first and second absorption wavelengths and a first emission wavelength, wherein the fluorescent dye emits measurably different light at the first and second absorption wavelengths.

2. The material of claim 1, wherein the fluorescent dye emits light that substantially corresponds to an “on” state at the first absorption wavelength and substantially corresponds to an “off” state at the second absorption wavelength.

3. The material of claim 2, wherein the first absorption wavelength is a peak absorption wavelength.

4. The material of claim 1, wherein the fluorescent dye is a photoswitchable fluorescent dye further comprising a second emission wavelength, wherein the fluorescent dye emits light that substantially corresponds to an “on” state at the first emission wavelength and substantially corresponds to an “off” state at the second emission wavelength.

5. The material of claim 1, further comprising a dispersive functional group attached to a surface of the fluorescent material, wherein the dispersive functional group improves dispersion of the fluorescent material.

6. The material of claim 1, wherein the first emission wavelength is at or above the visible spectrum and one of the first and second absorption wavelengths is in the ultraviolet spectrum.

7. The material of claim 1, wherein the fluorescent dye is a bridged fluorescent dye.

8. A method for producing a fluorescent material, comprising:
combining silane monomers and fluorescent silane dyes having first and second absorption wavelengths and a first emission wavelength, wherein the fluorescent silane dyes emit measurably different light at the first and second absorption wavelengths; and
initiating a polymerization reaction between the silane monomers and the fluorescent silane dyes, thereby creating a silica material with fluorescent dyes covalently bonded to a silica matrix.

9. The method of claim 8, wherein the fluorescent silane dye is a bridged fluorescent silane dye.

10. The method of claim 8, further comprising modifying a surface of the fluorescent material with a dispersive functional group, wherein the dispersive functional group improves dispersion of the fluorescent material.

11. The method of claim 8, further comprising performing a Stöber process or a microemulsion process.

12. The method of claim 8, wherein the fluorescent dye emits light that substantially corresponds to an “on” state at the first absorption wavelength and substantially corresponds to an “off” state at the second absorption wavelength.

13. The method of claim 8, wherein the fluorescent silane dyes have one of the first and second absorption wavelengths in the ultraviolet spectrum and the first emission wavelength is at or above the visible spectrum.

14. The method of claim 8, wherein the fluorescent silane dyes are photoswitchable fluorescent silane dyes further comprising a second emission wavelength.

15. A method for verifying authenticity of a product, comprising:
exposing a fluorescent material to light at a first absorption wavelength, the fluorescent material comprising a silica matrix and fluorescent dyes covalently bonded to the silica matrix, the fluorescent dyes having the first absorption wavelength, a second absorption wavelength, and a first emission wavelength, wherein the fluorescent silane dyes emit measurably different light at the first and second absorption wavelengths; and
detecting light at the first emission wavelength to verify the authenticity of the product.

16. The method of claim 15, further comprising inspecting the material using electron microscopy to determine whether a structural characteristic of the fluorescent material is present to verify the authenticity of the product.

17. The method of claim 15, further comprising:
exposing the fluorescent material to the second absorption wavelength; and
detecting light at the first emission wavelength to verify the authenticity of the product.

18. The method of claim 15, wherein one of the first and second absorption wavelengths is in the ultraviolet spectrum and the first emission wavelength is at or above the visible spectrum.

19. The method of claim 15, wherein the fluorescent dye emits light that substantially corresponds to an “on” state at the first absorption wavelength and substantially corresponds to an “off” state at the second absorption wavelength.

20. The method of claim 15, further comprising:
dispersing the fluorescent material in a substance at a predetermined concentration; and
detecting whether the fluorescent material fluoresces at a first predetermined intensity to verify the authenticity of the product.

21. The method of claim 15, wherein the fluorescent dye is a bridged fluorescent dye.

22. The method of claim 15, wherein the fluorescent dye is a photoswitchable fluorescent dye further comprising a second emission wavelength, and further comprising detecting light at the second emission wavelength to verify the authenticity of the product.
